(19) United States
(12) Patent Application Publication
(10) Pub. No.: US 2011/0154569 A1
(43) Pub. Date: Jun. 30, 2011

(54) MOBILE PATIENT SUPPORT SYSTEM

(75) Inventors: Robert T. WIGGERS, Belmont, CA (US); Reto W. FILIBERTI, Steinhausen (CH); Heinz VOGT, Baldingen (CH)

(73) Assignee: VARIAN MEDICAL SYSTEMS, INC., Palo Alto, CA (US)

(21) Appl. No.: 12/648,255

(22) Filed: Dec. 28, 2009

(51) Int. Cl. A61G 7/10; G01C 21/00

(52) U.S. Cl. 5/81.1 R

(57) ABSTRACT

A patient support system includes a base having a plurality of wheels, and a patient support coupled to the base, wherein at least a part of the patient support is for supporting a head of a patient, and at least one of the wheels has a plurality of secondary wheels. A patient support system includes a patient support, a transportation mechanism for transporting the patient support, a positioner for moving the patient support relative to the transportation mechanism, and a positioning system for determining an actual position associated with the patient support with respect to a multi-dimensional coordinate system, wherein one of the transportation mechanism and the positioner is for coarse positioning of the patient support, and another one of the transportation mechanism and the positioner is for fine positioning of the patient support.

### FIELD

This application relates generally to patient support system, and more specifically, to patient support system for use with radiation machines.

### BACKGROUND

Radiation therapy has been employed to treat tumorous tissue. In radiation therapy, a high energy beam is applied from an external source towards the patient. The external source, which may be rotating (as in the case for arc therapy), produces a collimated beam of radiation that is directed into the patient to the target site. The dose and placement of the dose must be accurately controlled to ensure that the tumor receives sufficient radiation, and that damage to the surrounding healthy tissue is minimized. Other treatment devices that deliver treatment beam for treating patient may employ protons or other heavy ions.

Before a treatment session, a region of the patient may be imaged to verify the shape, size, and location of the target region. Such may be accomplished by placing the patient on a support mounted next to an imaging device, wherein the support is specifically configured for use in an imaging session. The imaging session is then performed to obtain the image.

After the imaging session, the patient may then be placed on another support that is specifically for use in a treatment session. For example, the patient may be placed on another support that is mounted next to a radiation treatment device, wherein the radiation treatment device may be in a different station, but in a same room with the imaging device, or the radiation treatment device may be in a different room from that of the imaging device. A treatment session is then performed to deliver treatment radiation to treat the patient. The treatment session may include on-board imaging and re-positioning to ensure proper tumor/patient location. Additionally, external measuring devices: optical cameras, laser-surface scanners, magnetic positioning devices, etc may be used to augment final position of the patient/tumor.

In the above technique, the patient would need to be set up once at a first support for the imaging session, and another time at a second support for the treatment session. In each set up, the patient would need to be properly supported, and the position of the patient relative to the machine would need to be established and verified. Thus, using different patient supports for the imaging and treatment sessions can be time consuming, laborious, and inconvenient.

### SUMMARY

In accordance with some embodiments, a. patient support system includes a base having a plurality of wheels, and a patient support coupled to the base, wherein at least a part of the patient support is for supporting a head of a patient, and at least one of the wheels has a plurality of secondary wheels.

In accordance with other embodiments, a patient support system includes a patient support, a transportation mechanism for transporting the patient support, a positioner for moving the patient support relative to the transportation mechanism, and a positioning system for determining an actual position associated with the patient support with respect to a multi-dimensional coordinate system, wherein one of the transportation mechanism and the positioner is for coarse positioning of the patient support, and another one of the transportation mechanism and the positioner is for fine positioning of the patient support.

In accordance with other embodiments, a method of moving a patient includes receiving a signal, using the signal to determine an actual position of a reference point associated with a patient support that is supported on a transportation mechanism, comparing the actual position with a desired position, and operating the transportation mechanism based at least in part on a result of the act of comparing.

Other and further aspects and features will be evident from reading the following detailed description of the embodiments, which are intended to illustrate, not limit, the invention.

### BRIEF DESCRIPTION OF THE DAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

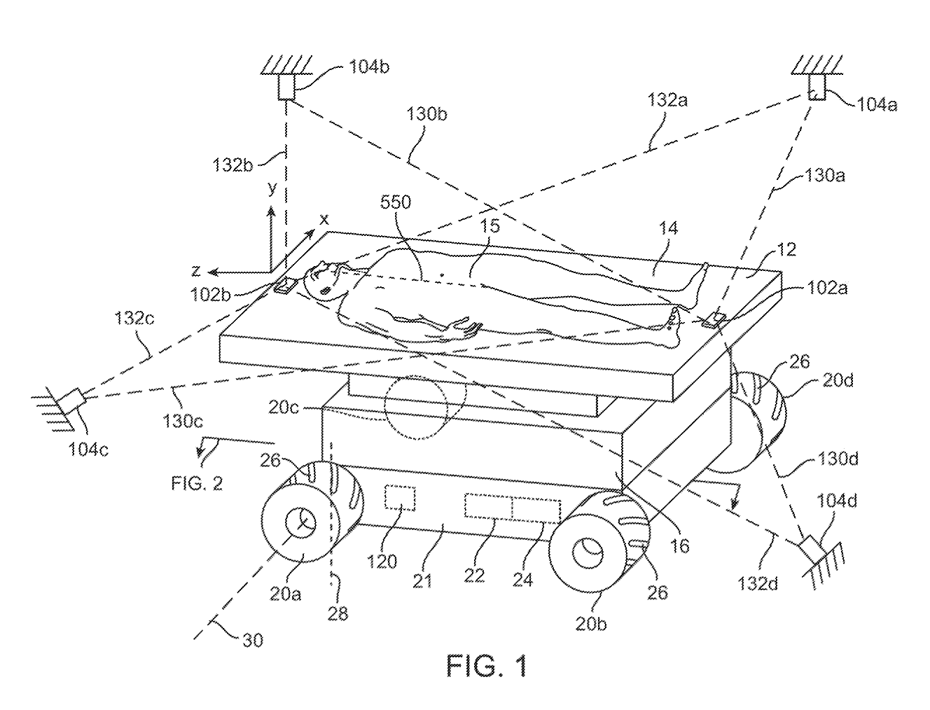

FIG. 1 illustrates a mobile patient support in accordance with some embodiments;

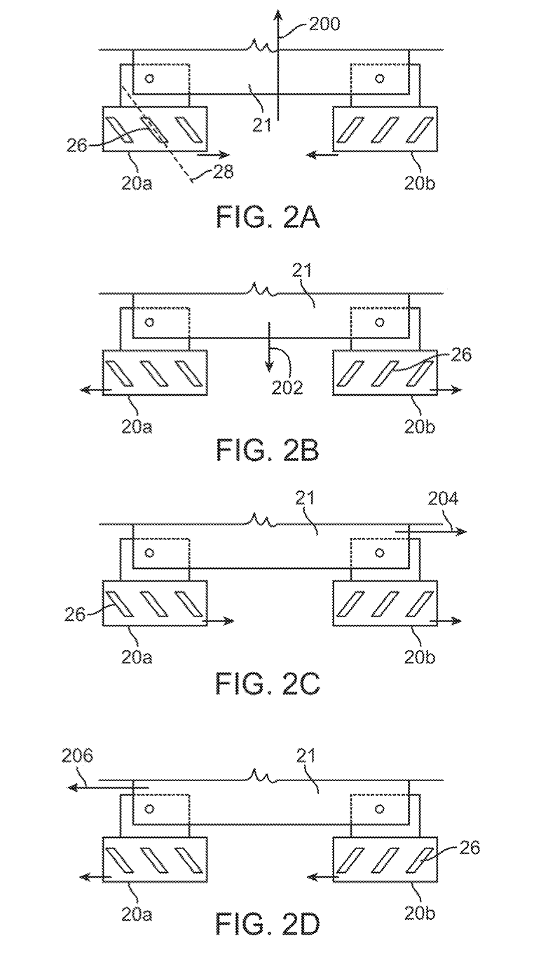

FIGS. 2A-2D illustrate different modes of operation of the wheels of the mobile patient support of FIG. 1 in accordance with some embodiments;

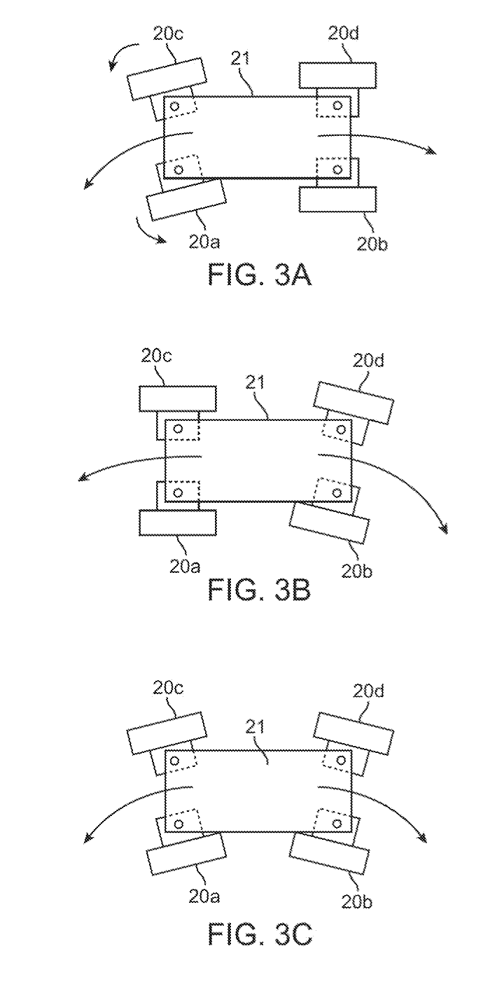

FIGS. 3A-3C illustrate different steering configurations of the wheels of the mobile patient support of FIG. 1 in accordance with some embodiments;

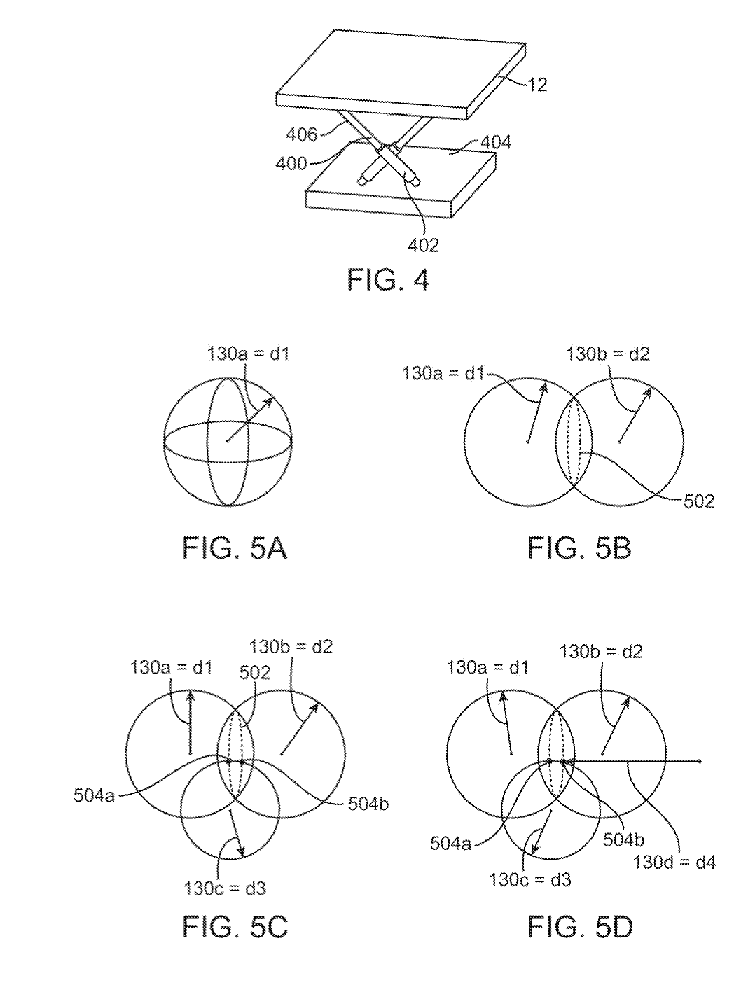

FIG. 4 illustrates a positioner for positioning a patient support of the mobile patient support of FIG. 1 in accordance with some embodiments;

FIGS. 5A-5D illustrates a concept of obtaining a position of a reference point using four measured distances;

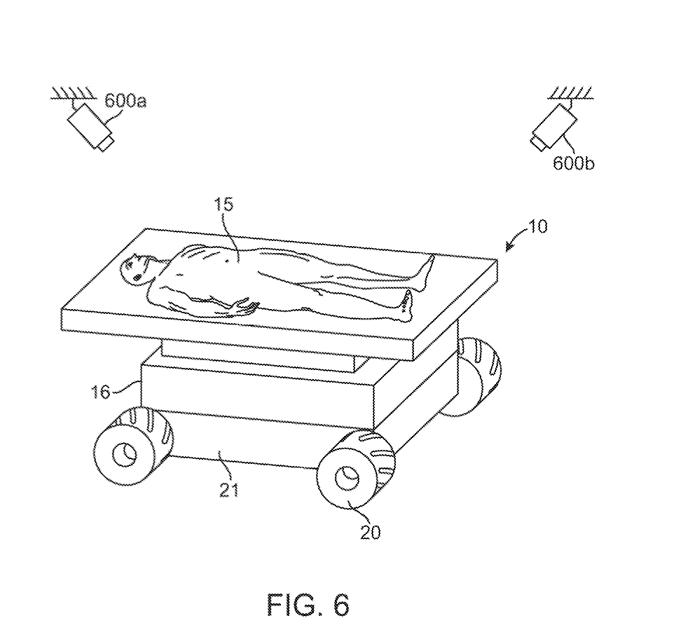

FIG. 6 illustrates a mobile patient support in accordance with other embodiments;

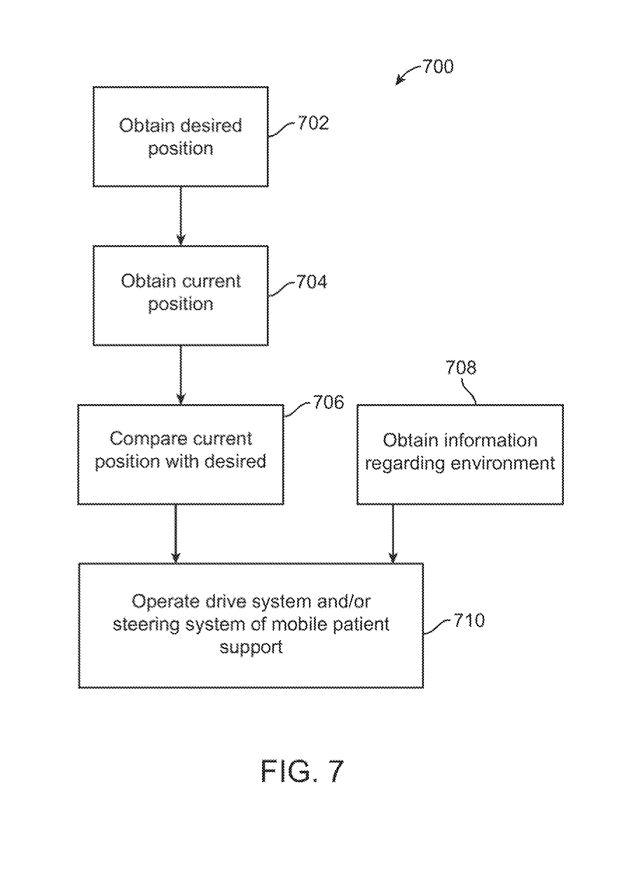

FIG. 7 illustrates a method for operating the mobile patient support of FIG. 1 in accordance with some embodiments;

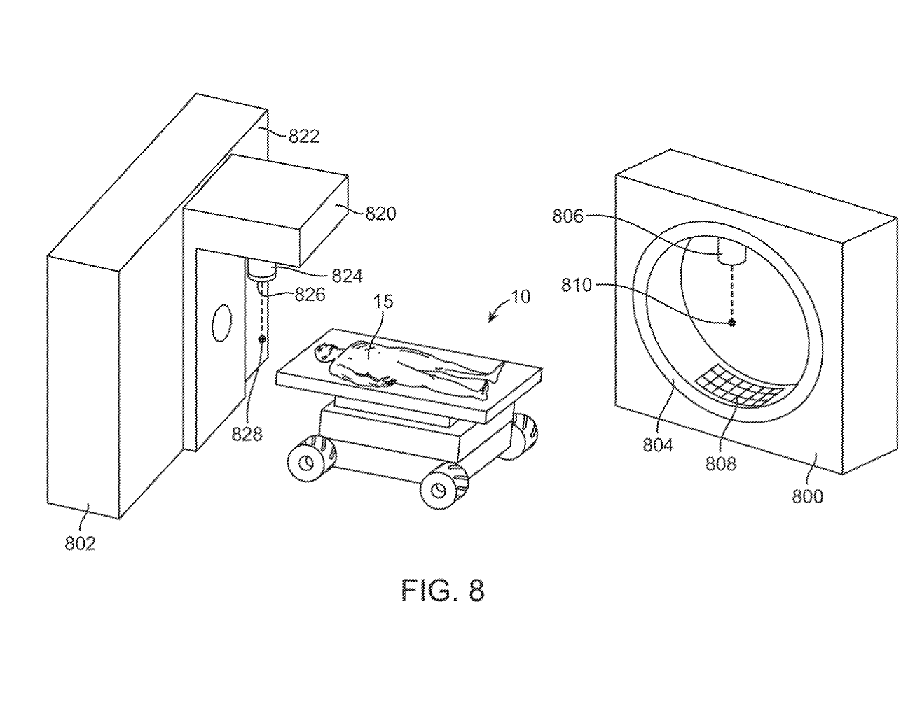

FIG. 8 illustrates the mobile patient support of FIG. 1 moving between stations;

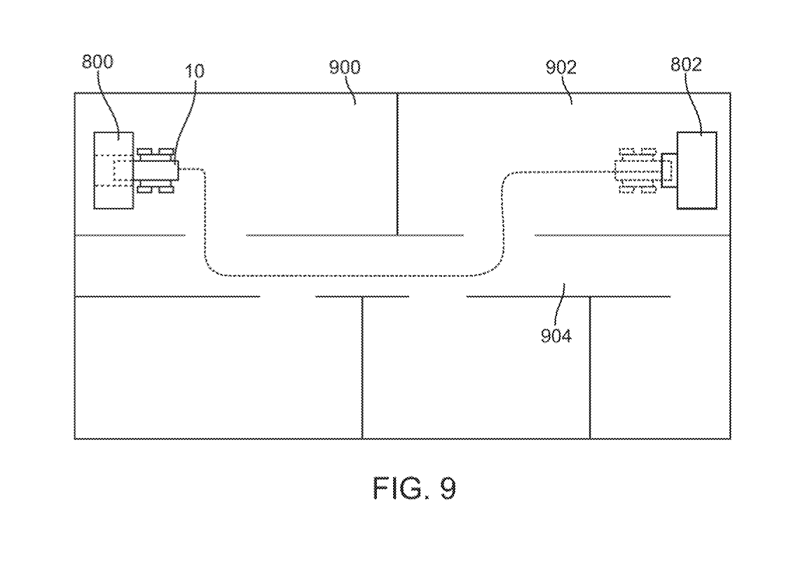

FIG. 9 illustrates the mobile patient support of FIG. 1 moving from one room to another room;

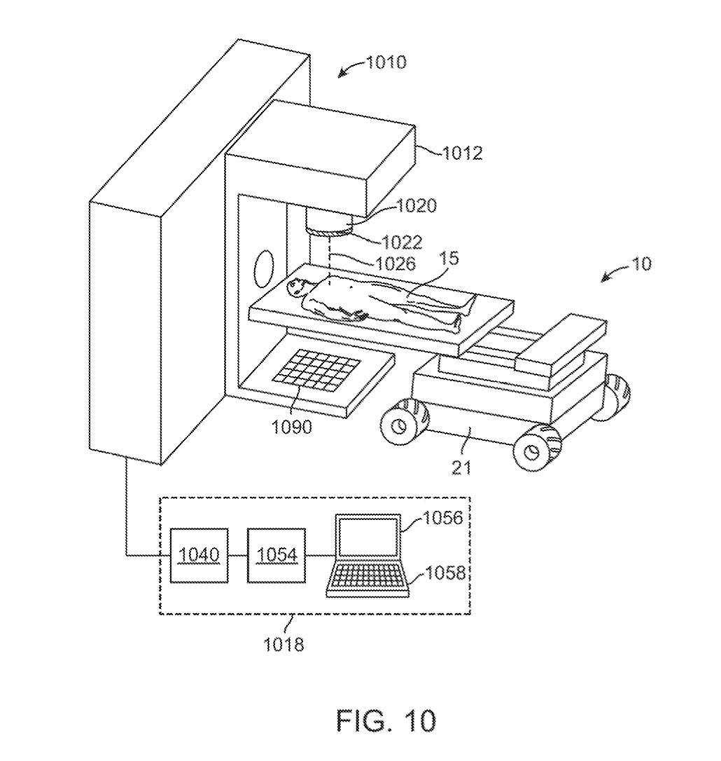

FIG. 10 illustrates the mobile patient support of FIG. 1 being used with a radiation machine; and

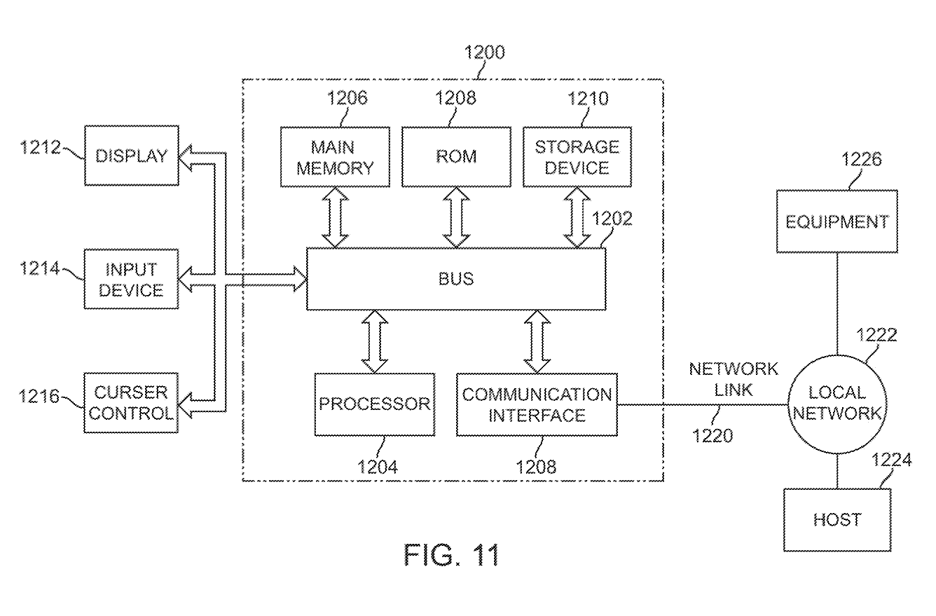

FIG. 11 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

Mobile Patient Support

FIG. 1 illustrates a mobile patient support 10 in accordance with some embodiments. The mobile patient support 10 includes a patient support 12 with a surface 14 for supporting a patient 15. The patient support 12 is coupled to a positioner 16, which is configured for moving the patient support 12 in one or more degrees of freedom, such as six degrees of freedom. For example, in some embodiments, the positioner 16 is configured to translate the patient support 12 relative to the positioner 16 in one or more degrees of freedom, such as along any one of three orthogonal axes (X, Y, Z). In other embodiments, instead of, or in addition to, translating the patient support 12, the positioner 16 may also be configured to rotate the patient support 12 relative to the positioner 16 about one or more the axes, such as about any one of three orthogonal axes (X, Y, Z).

As shown in the figure, the mobile patient support 10 also includes four wheels 20a-20d mounted to a base 21, a motor unit 22 for turning one or more of the wheels 20, and a steering unit 24 for steering one or more of the wheels 20. Although four wheels 20a-20d are shown, in other embodiments, the mobile patient support 10 may include less than four wheels (e.g., three wheels), or more than four wheels (e.g., six wheels). In some embodiments, the wheels 20 are part of a transportation system or mechanism. In other embodiments, the transportation system may further include the base 21, the motor unit 22, the steering unit 24, or a combination of the above.

Each of the wheels 20a-20d includes a plurality of secondary wheels 26 that are rotatably coupled to the wheel 20. In the illustrated embodiments, each of the second wheels 26 is configured to rotate about an axis 28 that forms an angle with an axis 30 of the wheel 20. Such configuration is desirable because it allows the mobile patient support 10 to be steered effectively by rotating the set of wheels 20a-20d in different patterns. For example, in some cases, wheels 20a, 20b may be rotated in opposite directions (and wheels 20c, 20d may be rotated in opposite directions), thereby resulting in movement of the mobile patient support 10 in the direction 200 shown in FIG. 2A. Alternatively, wheels 20a, 20b may be rotated in opposite directions that are opposite as those in FIG. 2A (and similar with wheels 20c, 20d), thereby resulting in movement of the mobile patient support 10 in the direction 202 shown in FIG. 2B. In other embodiments, all of the wheels 20 may be rotated in one direction, thereby moving the mobile patient support 10 in the direction shown in FIG. 2C. In further embodiments, all of the wheels 20 may be rotated in another direction that is opposite to that of FIG. 2C, thereby moving the mobile patient support 10 in the direction shown in FIG. 2D.

As illustrated in the above embodiments, the secondary wheels 26 are advantageous in that they allow the mobile patient support 10 (and therefore, the patient support 12) to be effectively positioned without the need to steer the mobile patient support 10 to turn along a curvilinear path. For example, at a given position of the mobile patient support 10, the mobile patient support 10 may be translated in one of two orthogonal directions. Such configuration allows the mobile patient support 10 to be easily moved to a desired position, such as, a position at which a reference point associated with the patient support 12 coincides with an isocenter of a machine.

In the illustrated embodiments, the motor unit 22 includes four subunits (sub-motor-units) for individually driving the wheels 20a-20d, respectively. In such cases, during use, one or more wheels may be turned at a different speed from that of another one or more wheels, thereby providing different movement behavior for the mobile patient support 10. Also, in some cases, one or more wheels may be turned while another one or more wheels may be held stationary. In other embodiments, the motor unit 22 may be a single unit that is configured to drive wheels 20a, 20c, wheels 20b, 20d, or wheels 20a-20d (four-wheel drive).

Also, in the illustrated embodiments, the steering unit 24 may include four subunits (sub-steering-units) for individually steering the wheels 20a-20d, respectively. During use, two of the sub-steering units may steer the wheels 20a, 20c (FIG. 3A), thereby allowing the mobile patient support 10 to move in a curvilinear manner. Alternatively, another two of the sub-steering units may steer the wheels 20b, 20d (FIG. 3B), thereby allowing the mobile patient support 10 to move in another curvilinear manner. In further embodiments, all four wheels 20a-20d may be steered (FIG. 3C), thereby allowing the mobile patient support 10 to move in another curvilinear manner. In particular, the configuration of FIG. 3C may be advantageous in that it allows the mobile patient support 10 to turn in a tight circle because the turning circle of the configuration of FIG. 3C is less than those in FIGS. 3A and 3B.

In some embodiments, the positioner 16 may be implemented using a hexpod. FIG. 4 illustrates the positioner 16 being implemented using a hexpod, which includes a plurality of actuators 400. Each actuator 400 has a first end 402 that is rotatably coupled (e.g., via a ball joint) to a support structure 404, and a second end 406 that is rotatably coupled (e.g., via a ball joint) to the patient support 12. Each actuator 400 has a length that may be adjusted during use. For example, each actuator 400 may have a first portion that is slidable relative to a second portion (such as two cylindrical members that are concentrically positioned). The movement of the first portion relative to the second portion may be accomplished using a driver, such as a hydraulic driver, a motor, etc. During use, the actuators 400 may be extended into different lengths, and/or rotated relative to the support structure 404, thereby positioning the patient support 12 in different degrees of freedom (e.g., along any one of three orthogonal axes, and/or about any one of three orthogonal axes).

In other embodiments, the positioner 16 may be implemented using other devices. For example, in other embodiments, the positioner 16 may include three (or less) linear actuators for translating the patient support 12 along three (or less) different respective axes, and three (or less) rotational actuators for tilting the patient support 12 about three (or less) different respective axes. In further embodiments, the positioner 16 may be implemented using one or more air cushions.

It should be noted that the positioner 16 should not be limited to the examples discussed, and that the positioner 16 may be implemented using any device that is known in the art in other embodiments. Also, in further embodiments, the positioner 16 does not need to provide movement for the patient support 12 in six degrees of freedom, and may provide movement in less than six degrees of freedom. For example, in other embodiments, instead of translating the patient support 12 along three different axes, the positioner 16 may be configured to translate the patient support 12 along one axis, such as a vertical axis (e.g., the Y axis). In such cases, the positioning of the patient support 12 along a plane that is perpendicular to the Y axis may be accomplished by operating the wheels 20.

Returning to FIG. 1, the mobile patient support 10 further includes a navigation system 100 that includes two signal receivers 102a, 102b, and four signal transmitters 104a-104d. In the illustrated embodiments, the receivers are coupled to the mobile patient support 10, and the transmitters are coupled to the room. In other embodiments, it is possible to reverse the transmitters and receivers such that the receivers are coupled to the room and the transmitters are coupled to the mobile patient support 10. The receivers 102 and transmitters 104 are within a building, e.g., within a room, and so the navigation system 100 is an in-room global positioning system (iGPS). As used in this specification, the term “in-room global positioning system” or “iGPS” refers to any system for determining a position associated with a device (wherein the position may be for a reference point on the device or not on the device) without using a satellite. Also, as used in this specification, the term “positioning system” or similar terms, such as “position determining system” refers to any device that is capable of determining a position (which may be a location, an orientation, or both) of an object. In the illustrated embodiments, each signal receiver 102 is configured to receive information from the transmitters 104. A processor 120 is provided for determining a position of the mobile patient support 10 based at least in part on the information. The processor 120 is coupled to the motor unit 22 and the steering unit 24 for controlling these units based at least in part on the determined position. In the illustrated embodiments, the processor 120 is physically coupled to the mobile patient support 10. Alternatively, the processor 120 may be physically uncoupled from the mobile patient support 10. For example, the processor 120 may be located at an operator's station. In such cases, information may be transmitted wirelessly between the mobile patient support 10 and the processor 120 at the operator's station. In some embodiments, the devices 102 may be considered as sensors. The devices 102 may be located under the support 12, on the support 12, on the patient 15, or coupled to other parts of the mobile patient support 10.

In the illustrated embodiments, the receivers 102a, 102b, and transmitters 104a-104d are ultrasound devices. During use, each transmitter 104 is configured to transmit an ultrasound signal to the receiver 102a. Upon receiving the ultrasound signals from the transmitters 104a-104d, the receiver 102a then transmits reply ultrasound signals back to the transmitters 104a-104d, respectively. Thus, as used in this specification, the term “receiver” is not limited to a device that can receive signal, and may refer to a device that can transmit signal, or both transmit and receive signals. Also, as used in this specification, the term “transmitter” is not limited to a device that can transmit signal, and may refer to a device that can receive signal, or both receive and transmit signals. For each transmitter 104, based on the speed of the ultrasound signal and the time delay that is measured from the time when it transmits the ultrasound signal, and the time when it receives the reply ultrasound signal back from the receiver 102a, the processor 120 can determine (e.g., based on the principle that distance=speed×time) a distance 130 that is between the transmitter 104 and the receiver 102a. In other embodiments, the transmitter 104 itself can be configured (e.g., built, programmed, etc.) to determine the distance 130. Thus, for a given moment in time, the distances 130a-130d that are between the receiver 102a and the transmitters 104a-104d, respectively, can be determined.

Based on the distances 130a-130d, the processor 120 can be configured to determine (e.g., calculate) the position of the receiver 102a. This is because four distances 130a-130d may be used to accurately determine the position of the receiver 102a. FIGS. 5A-5D illustrate an example of such concept. As shown in FIG. 5A, for a given distance 130a that is between the receiver 102a and the transmitter 104a, the receiver 102a may be located anywhere on a surface of a sphere 500a that has a radius equal to the distance 130a. On the other hand, as shown in FIG. 5B, if there are two distances 130a, 130b that are between the receiver 102a and two respective transmitters 104a, 104b, then the receiver 102a may be located anywhere on a circle 502 that represents the interception between two spheres 500a, 500b. The first sphere 500a has a radius that is equal to the first distance 130a, and the second sphere 500b has a radius that is equal to the second distance 130b. As shown in FIG. 5C, if three distances 130a-130c between the receiver 102a and three respective transmitters 104a-104c are available, then there are two possible locations 504a, 504b for the receiver 102a. In particular, the two locations 504a, 504b are located on the circle 502 that represents the interception between two spheres 500a, 500b. The two points 504a, 504b represent the interception of the circle 502 with a third sphere 500c, wherein the third sphere 500c has a radius equal to the distance 130c that is between the receiver 102a and the third transmitter 104c. As shown in FIG. 5D, if a fourth distance 130d that is between the receiver 102a and the fourth transmitter 104d is available, then the position of the receiver 102a may be accurately determined as one of the points 504a, 504b that lies on a surface of the sphere with radius equal to the distance 130d.

As illustrated in the above embodiments, the distances 130a-130d that are between the receiver 102a and the respective transmitters 104a-104d may be used to determine the position of the receiver 102a. The determined position, which is a three-dimensional coordinate of the receiver 102a, may then be used to determine (e.g., adopted as) the position of the mobile patient support 10.

In some case, the position of the second receiver 102b may be determined using the same technique as that described with reference to the first receiver 102a. For example, each of the transmitters 104a-104b may transmit an ultrasound signal to the second receiver 102b. Upon receiving the ultrasound signals from the transmitters 104a-104d, the receiver 102b then transmits reply ultrasound signals back to the transmitters 104a-104d, respectively. Based on the speed of the ultrasound signals, and the time for the ultrasound signals to transmit from the transmitters 104a-104d to the receiver 102b, and back from the receiver 102b to the respective transmitters 104a-104d, respective distances 132a -132d that are between the second receiver 102b and the transmitters 104a-104d may then be determined. The position of the second receiver 102b may then be determined using the distances 132a -132d, as similarly discussed.

The positions of the first and second receivers 102a, 102b may then be used to determine a position and/or an orientation of the mobile patient support 10. For example, in some embodiments, a midpoint on a line that is between the two positions of the receivers 102a, 102b may be used as the position of the mobile patient support 10. Also, the orientation of a line (that is between the two positions of the receivers 102a, 102b) relative to a reference coordinate system may be used to determine the orientation of the mobile patient support 10 with respect to the coordinate system. In the illustrated embodiments, the receivers 102a, 102b are placed on the mobile patient support 10 along a longitudinal axis 550. Thus, when the positions of the receivers 102a, 102b are determined, the orientation of the longitudinal axis 550 relative to a coordinate system may be determined.

It should be noted that the number of receivers 102 needs not be limited to two, and that in other embodiments, the mobile patient support 10 may include more than two receivers 102. For example, in other embodiments, the mobile patient support 10 may include a third receiver (not shown). The position of the third receiver may be determined using the same technique discussed. In some cases, the determined position of the third receiver, together with the positions of the first and second receivers 102a, 102b, may be used to determine a tilting angle (e.g., relative to a longitudinal axis) of the mobile patient support 10. In other cases, if the position of one of the receivers 102a, 102b cannot be determined (e.g., either the receiver become broken, or the position of the receiver cannot be accurately determined), the determined position of the third receiver may be used instead to determine the position and/or orientation of the mobile patient support 10. Thus, one or more receiver 102 may be a part of a redundancy system for determining a position and/or an orientation of the mobile patient support 10 in case a position of another receiver 120 may not be determined. In some cases, the redundancy system may also address insufficiency accuracy, and/or hazardous avoidance.

It should be noted in other embodiments, the mobile patient support 10 may use only one receiver 102. For example, when additional positioning devices are used (such as any of the modalities described herein, e.g., imaging, optical cameras, laser scanners, etc.), then the mobile patient support 10 may use only one receiver 102, since the additional positioning system will provide the additional positional information needed to accurately determine the position of the mobile patient support 10, and/or to correct the patient/tumor position.

Also, it should be noted that the number of transmitters 104 needs not be limited to four, and that in other embodiments, the mobile patient support 10 may be configured to communicate with more than four transmitters 104. Having more than four transmitters 104 is advantageous in that one or more of the transmitters may be parts of a redundancy system that allows the position of a receiver 102 to be determined if another transmitter 104 is unavailable (e.g., either the other transmitter 104 is broken, or because a line-of-sight between the other transmitter 104 and the receiver 102 is blocked). In some cases, the redundancy system may also address insufficiency accuracy, and/or hazardous avoidance.

In any of the embodiments described herein, a position of a receiver may be determined using less than four transmitters. For example, in some cases, if three distances between a receiver 102 and three respective transmitters 104 are available, and they provide two possible positions 504a, 504b for the receiver 102 (as similarly discussed with reference to FIG. 5C), and if one positions 504a, 504b is not possible (either because it would mean that the receiver 102 is at a physically impossible location, such as below a floor, in a next room, etc.), then the other position is selected as the position of the receiver 102. Also, in other embodiments, it is possible to use a previously known position as a reference. For instance, if a new position is measured (but with only 1, 2 or 3 reference distances 130/132), it would present two (or more) potential 3D locations. However, if a previously known position for a reference point (e.g., for a transmitter/receiver) is known, the distance from this point to each of the 3D potential locations may be determined. Considering the time delay between point acquisitions and the known motions speed, the processor can be configured to eliminate numerous 3D potential locations to obtain a single position for the reference point. For example, if the processor determines that one of the distances is too long based on the speed of the system 10 and the previously known position, then the processor may eliminate the potential 3D location that corresponds with that distance. In further embodiments, the distance between receivers/transmitters on the mobile support system 10 can be used to eliminate multiple 3D position locations. The elimination becomes more robust if one of the receivers has a definitive location.

In some embodiments, information regarding the operating environment of the mobile patient support 10 may be input into a memory associated with the processor 120. Such information may include the position and size of an obstacle (e.g., wall, equipment, door, etc.), available movement paths for the mobile patient support 10, map of the floor at which the mobile patient support 10 is to be operated, and target positions for the mobile patient support 10. The map of the floor and/or the positions and sizes of the obstacles allow the processor 120 to determine whether a determined position 504 is a possible position for the receiver 102. For example, based on the map and/or obstacle information, the processor 120 may determine that a determined position 504 of a receiver 102 is inside an obstacle, which would mean that the determined position 504 of the receiver 102 is not physically possible. In such case, the processor 120 may then select another determined position 504 as the position of the receiver 102 (assuming that there are two possible positions 504). The target position for the mobile patient support 10 may be an isocenter of a machine, such as an isocenter of a radiation treatment machine, or an isocenter of an imaging machine (e.g., a CT machine).

In the above embodiments, each distance 130/132 is determined based at least in part on signal transmitted from transmitter 104 to the receiver 102, and from the receiver 102 back to the transmitter 104. In other embodiments, each distance 130/132 may be determined based at least in part on signal transmitted from the receiver 102 to the transmitter 104, and from the transmitter 104 back to the receiver 102 (e.g., based on the principle that distance=speed of ultrasound signal×time it took for the signal to go from the receiver 102 to the transmitter 104 and back to the receiver 102).

In other embodiments, an ultrasonic technique may be used that involves receiving a reflection off a surface(s). Thus, as used in this specification, the term “receiver” is not limited to receiving a signal directly from a signal transmitter, and may refer to any device that receives signal indirectly (e.g., a reflected signal) from any object, such as a wall (which may be considered a device itself). Similarly, as used in this specification, the term “transmitter” is not limited to transmitting signal directly to a receiver, and may refer to any device that transmits signal to any object, such as a wall, which may reflect the signal to a signal receiver.

Although the above embodiments have been described with reference to the receivers 102 and transmitters 104 being implemented using ultrasound devices, in other embodiments, instead of using ultrasound devices, the navigation system 100 may use other devices. For example, in other embodiments, each of the receivers 102 and transmitters 104 may be a radio frequency (RF) device which is configured to receive and/or transmit RF signal(s). In such cases, the distances 130/132 may be determined using the RF signals. In some embodiments, the RF transmitters/receivers may be Ultra Low Frequency (ULF) transmitters/receivers. In some cases, giga-hertz radio frequencies may be used, which allows very small distances to be determined with great accuracy. However, either conventional frequency band or Spread-Spectrum bands may be used as well in other embodiments. In some embodiments, active RF tracking may be achieved using one of various implementations, such as time of flight (TOF), Frequency Phase Shift identification, which may be enhanced with phased arrays, etc. Also, in some embodiments, signal filtering may be implemented for filtering reflected signals that are reflected off walls or any other object.

In other embodiments, each of the receivers 102 and transmitters 104 may be an ultra wide band radio frequency (UWB) device which is configured to receive and/or transmit UWB signal(s). In such cases, the distances 130/132 may be determined using the UWB signals. UWB is similar to RF technology except that it may be better transmitted through objects, and thus, is less sensitive to objects that are between transmitter(s) 104 and receiver(s) 102. In some embodiments, active RF tracking may be achieved using one of various implementation, such as time of flight (TOF), Frequency Phase Shift identification, which may be enhanced with phased arrays, etc. Another advantage of UWB device over RF device is that UWB device may transmit and/or receive very short information pulses, which may offer better resolution for positioning. Also, in some embodiments, signal filtering may be implemented for filtering reflected signals that are reflected off walls or any other object.

In other embodiments, optical tracking may be used to implement the iGPS. In one implementation, one or more cameras 600a, 600b are used to view the mobile patient support 10 (FIG. 6). For example, one or more cameras may be mounted to a ceiling of a room. The camera(s) is then used to view the mobile patient support 10 as it is moved from place to place. In some embodiments, images from the camera(s) are transmitted to a processor (e.g., the processor 120 at the mobile patient support 10, or another processor, such as that at a user station), which processes the image signals to determine the position of the mobile patient support 10. In some cases, the processor may be configured to compare the image from the camera with a reference image (which may be a model of a known pattern) to thereby determine the position and orientation of the mobile patient support 10. In some embodiments, the processor may process the image from the camera to identify fiducials, such as markers or landmarks (that function as markers), and determine an input pattern for comparison with the reference image. The markers may be on the mobile patient support 10, and/or on the patient. Similarly, if landmarks are used, the landmarks may be on the patient support 10, and/or on the patient. Once the position of the mobile patient support 10 is determined, the processor 120 (or another processor) then compares the determined position with a desired position, and based at least in part on a result of the comparison, transmits control signal(s) to control the motor unit 22 and/or the steering unit 24 to thereby drive the mobile patient support 10 to a desired position.

In other embodiments, laser measurement may be used to implement the iGPS. In one implementation, distance sensing lasers are used to locate the mobile platform within a desired position tolerance. Use of laser measurement would require line-of-sight between the laser and the mobile patient support 10. However, such requirement may be satisfied by placing the laser at a location (such as at the ceiling of a room) that maximizes the amount of line-of-sight between the laser and the platform at different positions within the room. Various techniques, such as time of flight (TOF), triangulation, and inferometry (phase shift), etc., may be used to implement laser measurements. In some embodiments, the navigation system 100 includes one or more distance sensing lasers that are fixed in position relative to an environment, such as a room. Such distance sensing laser is non-movable during use, and is configured to determine a distance along a predefined direction. In other embodiments, the navigation system 100 may include one or more laser scanner(s) for determining the position and orientation of the mobile patient support 10. Such laser scanner may include a rotating head for producing a stream of distance measurements. The distance measurements are transmitted to a processor (e.g., processor 120), which uses the distance measurements to generate a topographic map of the environment. From the topographic map, the processor can then determine the position and orientation of the mobile patient support 10. In further embodiments, laser scanner(s) may be used to generate position information for distant markers located on the moving mobile patient support 10. Each marker may be a marker device coupled to the mobile patient support 10, a component of the mobile patient support 10, or a fiducial (e.g., a marker device, a landmark on the patient, etc.) on a patient that is being supported on the mobile patient support 10. In such cases, the navigation system 100 may include multiple laser readers and markers to thereby determine a three-dimensional position and orientation of the mobile patient support 10.

The navigation system 100 is not limited to using the above techniques/device. In other embodiments, the navigation system 100 may use other techniques/devices, such as any non-contact distance measuring technology.

In further embodiments, the position of the mobile patient support 10 may be determined using odometery. In such cases, the processor 120 is configured to determine a number of rotations (or an amount of a partial rotation) of a wheel with a known circumference. As the mobile patient support 10 is moved, the wheel (which is located at a bottom of the mobile patient support 10, or may be rotatably coupled to one of the wheels 20) will turn accordingly. Based on an amount of rotation undergone by the wheel, the processor 120 can then determine a distance travelled by the mobile patient support 10. In some cases, if the steering of the wheels 20 is monitored, the processor 120 may be configured to calculate the position of the mobile patient support 10 based at least in part on the path (i.e., the direction and distance of the path) that it has travelled. In other embodiments, instead of using a separate wheel for implementing the odometery, one or more of the wheels 20 may be used. In some embodiments, the odometery system may be used with any of the techniques described herein for determining the position of the mobile patient support 10. For example, the odometery system may be used for coarse positioning, while the transmitter-receiver system may be used for fine positioning.

In other embodiments, the mobile patient support 10 may use an inertial navigation technique to assist in determining the position and orientation of the mobile patient support 10. In the inertial navigation technique, a magnetic compasses, one or more accelerometer(s), one or more force sensing devices, and/or one or more gyroscope(s) is used to determine a turning (and therefore, an orientation relative to a reference) of the mobile patient support 10. The inertial navigation technique may be used with any of the positioning techniques described herein.

In still further embodiments, the mobile patient support 10 may use landmark navigation technique to determine the position of the mobile patient support 10. This involves placement of objects along the path or in the area of desired motion. In such cases, the mobile patient support 10 has a sensor for sensing such objects (beacons). Each such object provides a unique positional information. Thus, by sensing the objects, the position of the mobile patient support 10 may be determined. In some embodiments, the objects to be sensed by the sensor of the mobile patient support 10 may be lines or a grid, and the sensor may use any of the techniques known in the art for sensing such object(s). For example, the sensor may be an optical sensor, a magnetic sensor, a vibration sensor, etc., for sensing the object(s).

In some embodiments, landmark may also be used to assist the mobile patient support 10 to steer itself. For example, in some embodiments, red lines may be placed on the floor to indicate possible paths for the mobile patient support 10. In such cases, the mobile patient support 10 may include a camera for viewing the red lines. During use, images are transmitted to the processor 120, which processes the images to identify the red lines. The processor 120 then drive and steer the mobile patient support 10 so that it follows the red lines to a prescribed target position. In other embodiments, instead of red lines, other landmarks may be used. Also, in further embodiments, the lines/landmarks may be formed using magnet(s), reflector(s), capacitive device(s), or any device(s) that is capable of being sensed by sensor(s).

In any of the embodiments described herein, the position of the mobile patient support 10 may be determined relative to a pre-defined origin. In some cases, the origin may be defined by entering the origin information into the processor 120. Such may be performed during a calibration procedure or an initial setup process. Once the origin is defined, the position of the mobile patient support 10, as well as any prescribed target position(s) for the mobile patient support 10, and positional information regarding the topography of the operating environment (such as a position of an obstacle, e.g., a wall), may be expressed relative to the defined origin. In some embodiments, the mobile patient support 10 may be used with a treatment machine and a diagnostic machine (such as that shown in the example of FIG. 8, described below). The treatment machine may have its own coordinate system with axes, X_{T}, Y_{T}, and Z_{T}, the diagnostic system 100 may have its own coordinate system with axes X_{D}, V_{D}, and Z_{D}, and the mobile patient support 10 may have its own coordinate system with axes X_{P}, Y_{P}, and Z_{P}. In such cases, positions that are expressed in the coordinate system of the treatment machine (such as the position of the isocenter) may be expressed relative to the defined origin for the mobile patient support 10. Similarly, positions that are expressed in the coordinate system of the diagnostic machine (such as the position of the isocenter) may be expressed relative to the defined origin for the mobile patient support 10.

In some embodiments, the navigation system 100 may be implemented using a hybrid solution that combines two or more of the above described techniques. Using more than one techniques provides a robust unambiguous solution for the position and orientation of the mobile patient support 10, and may also help in safety mitigation by offering two or more position feedbacks.

It should be noted that the navigation system 100 is not limited to the examples described above, and that in other embodiments, the navigation system 100 may be implemented using other techniques.

Method of Using the Mobile Patient Support

FIG. 7 illustrates a method 700 of using the mobile patient support 10 in accordance with some embodiments. During use, the processor 120 receives information regarding a desired position for the patient support 12 (step 702). Such may be accomplished by manually inputting the information into the processor 120 through a user interface at the mobile patient support 10, such as a touch screen, one or more buttons, a knob, etc. Alternatively, the information regarding the desired position for the patient support 12 may be input into the processor 120 automatically from another device (which may be a different or related control system), either through a cable or wirelessly. In the case of a wireless transmission, the mobile patient support 10 may further include a wireless receiver (not shown) coupled to the processor 120. The information may be broadcast using a transmitter in the room, or another transmitter, such as a hand held device (a remote control) for use by an operator.

In some embodiments, the desired position of the patient support 12 may be a desired position for a reference point that is associated with the patient support 12. For example, the reference point may be a point located on the patient support 12, such as a point located at the receiver 102a/102b, or the midpoint between the receivers 102a, 102b. In another example, the reference point may be a point that is away from the patient support 12, such as a point that is a prescribed distance away from a certain location at the patient support 12, or a point that is on/in the patient.

In some cases, the information regarding the desired position for the patient support 12 received by the processor 120 may include a plurality of desired positions. In such cases, a plurality of positions may be prescribed to be achieved by operating the mobile patient support 10 such that a reference point associated with the patient support 12 is at the desired positions. For example, in some embodiments, a first desired position may be a location of an isocenter of an imaging device, and a second desired position may be a location of an isocenter of a treatment device. In other embodiments, a first desired position may be a first treatment position, and a second desired position may be a second treatment position. In further embodiments, a first desired position may be a first imaging position, and a second desired position may be a second imaging position. In some embodiments, the desired positions may be parts of a treatment plan.

Next, the current position of the mobile patient support 10 is determined (Step 704). In the illustrated embodiments, the receivers 102 and the transmitters 104 may be used to provide the processor 120 with information regarding distances 130, 332 that are between the receivers 102 and the transmitters 104. The processor 120 processes the information, and calculates the positions of the receivers 102a, 102b, as discussed.

Next, the current position of the patient support 12 is compared with the desired position (Step 706). If the current position of the patient support 12 is not at the desired position, the processor 120 then operates the motor unit 22 and/or the steering unit 24 to drive the mobile patient support 10 such that the patient support 12 is moved towards the desired position (Step 710). In some cases, instead of, or in addition to, operating the motor unit 22 and the steering unit 24, the processor 120 may also operate the positioner 16 to move the patient support 12 relative to the base 21. For example, in some embodiments, the mobile patient support 10 may be driven to an area where the desired position is located, and then the positioner 16 is operated to move the patient support 12 to the desired position. Thus, the motor unit 22 and the steering unit 24 may be used to perform coarse positioning of the patient support 12, while the positioner 16 may be used to perform fine positioning of the patient support 12. In other embodiments, the motor unit 22 and the steering unit 24 may be configured to perform fine positioning of the mobile patient support 10. As used in this application, the term “fine positioning” refers to positioning of an object with millimeter or sub-millimeter accuracy, and the term “coarse positioning” refers to positioning of an object with accuracy that is above 1 millimeter.

In one implementation, the motor unit 22 and the steering unit 24 are configured to provide four degrees of freedom: translation in the X, Y and Z directions, and rotation about the Y-axis. If the absolute accuracy of these drives is not sufficient, then the positioner 16 may be configured to provide fine positioning (e.g., for translation in the X, Y, and Z directions, and/or rotation about X, Y, and Z axes). For fine positioning, the range of translation may be any where between 2-4 cm, and the range of rotation may be less than 5°. In other embodiments, the range of translation and the range of rotation may have other values. In other embodiments, if the motor unit 22 and the steering unit 24 are sufficient in providing accurate positioning of the patient support 12, then the positioner 16 may be configured to provide additional drive for rotation about the X and Z axes. It should be noted that embodiments described herein are not limited to these axis configurations, and that other configurations are possible. For example, in other embodiments, the positioner 16 may be configured to move the patient support in any degree of freedom. In such cases, the positioner 16 does not have any fixed axis configuration.

In the illustrated embodiments, the mobile patient support 10 is configured to automatically steer itself to a desired position in an operation room.

In other embodiments, the mobile patient support 10 may include a control, such as a steering wheel or a joystick (not shown), which allows a user to manually steer the mobile patient support 10 to a desired position in an operation room. In such cases, the control is coupled to the motor unit 22 and the steering unit 24, which operate to turn and/or steer the wheels in response to signals received from the control. Alternatively, the control may be detached from the mobile patient support 10. For example, the control may be located at a user station, or may be implemented on a hand-held device. In further embodiments, the mobile patient support 10 may be configured to have both auto-steering functionality and the manual-steering functionality. In such cases, the mobile patient support 10 may include a switch for allowing a user to select between auto-steering mode and manual-steering mode. In the auto-steering mode, the processor 44 operates the motor unit 22 and/or the steering unit 24 to automatically steer the mobile patient support 10. In the manual-steering mode, the control is used by the user to drive the mobile patient support 10. In some applications, a user may use the manual-steering feature to steer the mobile patient support 10 to an area that is close (e.g., within 6 inches, and more preferably, within 1 inch) to a target position. The user may then switch from the manual-steering mode to the auto steering mode, and allows the mobile patient support 10 to steer and/or position itself so that the patient support 12 is at a desired position. Thus, in this example, the manual-steering feature is for coarse positioning the mobile patient support 10, and the auto-steering feature is for fine positioning. In other embodiments, the auto-steering feature may be for coarse positioning, and the manual-steering feature may be for fine positioning. In some embodiments, the manual-steering may allow a user to manually drive the mobile unit, while the auto-steering helps prevent collisions. For example, if a user steers the mobile unit towards a wall, and the processor detects that a collision is about to occur, then the processor may auto-steer (e.g., stop the unit, or change the driving direction, etc.) to prevent the collision from occurring. In other embodiments, when auto-steering is used to drive the mobile unit, manual override is allowed to thereby allow a user to take over the control of the mobile unit.

In some embodiments, the mobile patient support 12 may be steered from a first operative position that is associated with a first machine to a second operative position that is associated with a second machine. Each of the first and the second machines may be an imaging device, a treatment device, or both. FIG. 8 illustrates an example of such feature. As shown in the figure, the mobile patient support 10 is being positioned from a first station that includes an imaging machine 800 to a second station that includes a treatment machine 802. In the illustrated example, the imaging machine 800 is a CT machine that includes a rotatable ring gantry 804, a imaging radiation source 806, and an imager 808. An isocenter 810 associated with the CT machine is shown. However, in other embodiments, the CT machine may have different configurations. Also, in other embodiments, instead of being a CT machine, the imaging machine 800 may be a PET machine, a SPECT machine, a PET-CT machine, an x-ray machine, an ultrasound machine, a MRI machine, a tomosynthesis imaging machine, etc. Also, in the illustrated example, the treatment machine 802 is a radiation machine configured to deliver treatment radiation. The radiation machine 802 includes an arm 820 rotatably coupled to a structure 822, a treatment radiation source 824, and a collimator 826. An isocenter 828 associated with the radiation machine 802 is shown. In other embodiments, the treatment radiation machine 802 may have different configurations. For example, in other embodiments, the treatment radiation machine 802 may have a ring gantry instead of the arm 820. Also, in other embodiments, the treatment machine 802 may not be configured to deliver treatment radiation, and may instead be configured to deliver other forms of energy for treating the patient. For example, in other embodiments, the treatment machine 802 may be a proton (or other heavy ion based) machine for delivering proton beam (or other heavy ion beams) to treat the patient. In further embodiments, the treatment machine 802 may include one or more surgical tools for operating on the patient.

In some cases, for each machine, the iGPS is provided to achieve a desired accuracy for the machine. When moving between the machines, the iGPS can either be a continuous system, so that one iGPS system may be used to move the mobile unit between the machines, and to achieve accurate positioning at each of the machines. Alternatively, each room (area) may have a dedicated iGPS system.

In the above example, both machines 800, 802 are located in a single room, and the mobile patient support 10 is illustrated as moving within the room from one machine to the other. In other embodiments, the machines 800, 802 may be located in different rooms. FIG. 9 illustrates an example of such concept, particularly showing the mobile patient support 10 being steered from a first room 900 that includes the first machine 800 to a second room 902 that includes the second machine 802. In the illustrated example, the mobile patient support 10 needs to travel through a hallway 904 in order to get to the second room 902. In such cases, sensor(s), transmitter(s), or receiver(s), etc., that are part of the navigation system 100 for the mobile patient support 10 may be placed in the hallway 904, thereby allowing the processor 120 to determine the actual position and orientation of the mobile patient support 10 while it is moving. In some embodiments, information regarding the map of the floor is input into the processor 120, which uses such information to control the steering and driving of the mobile patient support 10.

It should be noted that the mobile patient support 10 is not limited to being used for only two systems, and that in other embodiments, the mobile patient support 10 may be used for more than two systems. For example, in some cases, it may be necessary for the patient to be moved among three (or more) locations, such as, from surgery to imaging to treatment back to surgery, or from Imaging to simulation to treatment, etc.

In further embodiments, instead of using the mobile patient support 10 in a single floor, the mobile patient support 10 may be used in multiple floors of a building (e.g., a hospital). For example, in some embodiments, the first machine 800 may be located in one room at a first floor, and the second machine 802 may be located in another room at a second floor. In such cases, the mobile patient support 10 may steer itself automatically from the first machine 800 to the second machine 802, and vice versa. Alternatively, the steering of the mobile patient support 10 may be performed manually by a user operating on a control, as discussed. In further embodiments, the steering of the mobile patient support 10 may be done both automatically and manually. For example, the processor 120 may be configured to automatically steer the mobile patient support 10 from one room at one floor to another room at another floor to thereby place the mobile patient support 10 in a vicinity of a station that includes a machine. Then the user may operate the control to position the patient support 12 for fine positioning such that a reference point associated with the patient support 12 is at a desired operative position (e.g., an isocenter) associated with the machine. Alternatively, the user may steer the mobile patient support 10 from one room at one floor to another room at another floor to thereby place the mobile patient support 10 in a vicinity of a station that includes a machine. Then the processor 120 may automatically position the patient support 12 for fine positioning such that a reference point associated with the patient support 12 is at a desired operative position (e.g., an isocenter) associated with the machine.

In any of the embodiments described herein, the patient support 12 may be detachable from the remaining part, such as the positioner 16, of the mobile patient support 10. In some cases, the detached patient support 12 may be detachably coupled to a base, such as a bed frame. In some embodiments the patient support 12 is interchangeable. The interchange by happen through various methods, such as direct manual replacement, rolling/interfacing cart, etc. In addition, at the time of the exchange (e.g., from a bed frame to the mobile patient support), the patient may or may not be already located on the support 12. During use, the patient support 12 may be initially coupled to the base, and is used to support the patient 15 while the patient 15 is being prepared for treatment (e.g., while the patient 15 is in a different room from the treatment room). After the patient 15 is prepared, the patient support 12 supporting the patient 15 is then decoupled from the base (e.g., a bed frame), and is coupled to the remaining part of the mobile patient support 10. The mobile patient support 10 may then be used to transport the patient 15 to an operative position for treatment. For example, the mobile patient support 10 may be used to move the patient 15 to a different room, e.g., a treatment room, in which the patient 15 will be treated. In another example, the mobile patient support 10 may move the patient 15 from one location in a room to another location in the same room for treatment. The mobile patient support 10 may transport and position the patient support 12 automatically using the iGPS in accordance with embodiments described herein. Alternatively, a user may manually operate the mobile patient support 10. In further embodiments, the user may manually operate the mobile patient support 10 during part of the patient setup process, and allows the mobile patient support 10 to steer and/or to position the patient support 12 during another part of the patient setup process.

In other embodiments, a plurality of different patient supports may be provided, and during use, one of the patient supports is selected for attachment to the mobile patient support 10. In such cases, the different patient supports may have different configurations (e.g., different sizes, shapes, functionalities, etc.).

Also, in any of the embodiments described herein, instead of attaching the sensors/transmitters at the mobile patient support 10, one or more of the sensors)/transmitter(s) may be coupled to the patient.

As illustrated in the above embodiments, the mobile patient support 10 and the method 700 provides several advantages. First, patient setup is not required to be performed in a treatment room or in a diagnostic room. Rather, patient setup may be performed in any places, such as the patient's room (because the mobile patient support 10 may be steered to any places). Also, patient off-loading may be performed outside the treatment room or outside the diagnostic room. The mobile patient support 10 is mechanically and electronically independent from the treatment/diagnostic machines, thereby allowing the mobile patient support 10 to be used in a variety of applications and procedures without limiting it to a specific machine. Also, in the embodiments in which the height of the patient support 12 may be adjusted, use of the mobile patient support 10 does not require a precisely leveled floor. This is because during use, the height of the patient support 12 may be adjusted to compensate for any unevenness or any slopping that may exist at the floor supporting the mobile patient support 10. Furthermore, unlike some of the existing patient supports that require a large base frame that is to be mounted to a pit, the mobile patient support 10 does not require any pit to be constructed at a floor, nor does it require a large base frame to be mounted to any floor pit. The mobile patient support 10 does not require any of its components to be fixedly mounted to a floor. In addition, unlike some existing patient supports that use a docking system, which requires a docketing device to be permanently mounted in a room, the mobile patient support 10 does not require any permanently mounted docketing device.

In any of the embodiments described herein, in addition to using the mobile patient support 10 to transport the patient 15 from one machine to another machine, the mobile patient support 10 may also be operated to position the patient 15 during a treatment or a diagnostic procedure. FIG. 10 illustrates the mobile patient support 10 being used with a radiation machine during a procedure. In the illustrated embodiments, the radiation machine is a radiation treatment system 1010. However, in other embodiments, the radiation machine may be a diagnostic system.

The radiation treatment system 1010 includes a gantry 1012 (in the form of an arm), and a control system 1018 for controlling an operation of the gantry 1012. The system 1010 also includes a radiation source 1020 that projects a beam 1026 of radiation towards the patient 15 while the patient 15 is supported by the mobile patient support 10, and a collimator system 1022 for controlling a delivery of the radiation beam 1026. The radiation source 1020 can be configured to generate a cone beam, a fan beam, or other types of radiation beams in different embodiments.

In the illustrated embodiments, the radiation source 1020 is a treatment radiation source for providing treatment energy. In other embodiments, in addition to being a treatment radiation source, the radiation source 1020 can also be a diagnostic radiation source for providing diagnostic energy. In such cases, the system 1010 will include an imager, such as the imager 1090, located at an operative position relative to the source 1020. Alternatively, the imager 1090 may be coupled to the mobile patient support 10 (e.g., under the support 12). In such cases, during use, the imager 1090 may be placed to an operative position relative to the source 1020 by positioning the mobile patient support 10 (e.g., steering the mobile patient support 10 and/or moving the support 12). In some embodiments, the treatment energy is generally those energies of 160 kilo-electron-volts (keV) or greater, and more typically 1 mega-electron-volts (MeV) or greater, and diagnostic energy is generally those energies below the high energy range, and more typically below 160 keV. In other embodiments, the treatment energy and the diagnostic energy can have other energy levels, and refer to energies that are used for treatment and diagnostic purposes, respectively. In some embodiments, the radiation source 1020 is able to generate X-ray radiation at a plurality of photon energy levels within a range anywhere between approximately 10 keV and approximately 20 MeV. In further embodiments, the radiation source 1020 can be a diagnostic radiation source. In the illustrated embodiments, the radiation source 1020 is coupled to the arm gantry 1012. Alternatively, the radiation source 1020 may be located within a bore (for example, the source 1020 may be coupled to a ring gantry that defines the bore).

In the illustrated embodiments, the control system 1018 includes a processor 1054, such as a computer processor, coupled to a control 1040. The control system 1018 may also include a monitor 1056 for displaying data and an input device 1058, such as a keyboard or a mouse, for inputting data. In the illustrated embodiments, the gantry 1012 is rotatable about the patient 15, and during a treatment procedure, the gantry 1012 rotates about the patient 15 (as in an arch-therapy). In other embodiments, the gantry 1012 does not rotate about the patient 15 during a treatment procedure. In such case, the gantry 1012 may be fixed, and the patient support 12 is rotatable. The operation of the radiation source 1020, the collimator system 1022, and the gantry 1012 (if the gantry 1012 is rotatable), are controlled by the control 1040, which provides power and timing signals to the radiation source 1020 and the collimator system 1022, and controls a rotational speed and position of the gantry 1012, based on signals received from the processor 1054. Although the control 1040 is shown as a separate component from the gantry 1012 and the processor 1054, in alternative embodiments, the control 1040 can be a part of the gantry 1012 or the processor 1054.

It should be noted that the radiation system 1010 is not limited to the configuration described above, and that the radiation system 1010 may have other configurations in other embodiments. For example, in other embodiments, the radiation system 1010 may have a different shape. In other embodiments, the radiation source 1020 of the radiation system 1010 may have different ranges of motions and/or degrees of freedom. For example, in other embodiments, the radiation source 1020 may be rotatable about the patient 15 completely through a 360° range, or partially through a range that is less than 360°. Also, in other embodiments, the radiation source 1020 is translatable relative to the patient 15. In addition, in other embodiments, the gantry 1012 may be tiltable about one or more axes. Further, the radiation source 1020 is not limited to delivering treatment energy in the form of x-ray, and may deliver other types of radiation energy. For example, in other embodiments, the radiation source 1020 may be a proton source for delivering protons to treat patient, or other types of particle source for delivering other types of particles for treating patient. Thus, as used in this specification, the term “radiation” is not limited to x-ray, and may refer to a particle beam, such as a proton beam.

In some embodiments, during a treatment session, the patient support 12 may be positioned (e.g., using the positioner 16, the drive unit 22, the steering unit 24, or any combination thereof) to change a position of the patient 15 relative to the treatment machine 1010. For example, the patient support 12 may be translated about the Z-axis, about the X-axis, about the Y-axis, or about any combination of these axes. The patient support 12 may also be rotated about any of these axes. In some embodiments, the movement of the patient support 12 may occur simultaneously with movement of the gantry 1012. Alternatively, the movement of the patient support 12 may occur before or after a movement of the gantry 1012.

Although the above embodiments have been described with reference to delivering treatment radiation that is in the form of x-rays, in other embodiments, the system and technique described herein may be used for other types of treatment energy. For examples, in other embodiments, in other embodiments, the radiation source 1020 may be a proton source for delivering protons to treat a patient, or an electron source for delivering electrons. Accordingly, embodiments of the treatment planning technique described herein may be used to determine treatment plan for other types of treatment, such as proton treatment. Also, it should be noted that the term “collimator” is not limited to a device having leaves for blocking radiation, and may refer to a device having one or more jaws or jaw blocks. Thus, a position of a collimator may refer to position of leaves of a collimator, position of collimator jaws, or a global position of the collimator itself relative to some coordinate system (e.g., a position of the collimator relative to a gantry or relative to a radiation machine, etc.).

It should be noted that the treatment machine 1010 is not limited to the example described above, and that the treatment machine 1010 may have different configurations in other embodiments. For example, in other embodiments, instead of delivering x-ray treatment beam, the treatment machine 1010 may be configured to deliver a proton beam for treating the patient 15. In such case, the treatment machine 1010 is a proton treatment machine that includes a proton source. In other embodiments, the treatment machine 1010 may not include any radiation source. Instead, the treatment machine 1010 may include an operative device, such as a surgical cutter, an ablation device, a drug injection device, etc., for treating the patient 28.

Also, in other embodiments, instead of, or in addition to, using the mobile patient support 10 during a treatment session, the mobile patient support 10 may be used during a diagnostic session. For example, in some embodiments, the mobile patient support 10 may be used to position the patient 15 relative to an imaging machine, such as a CT machine. For example, the patient support 12 may be translated about the Z-axis, about the X-axis, about the Y-axis, or about any combination of these axes. The patient support 12 may also be rotated about any of these axes. In some embodiments, the movement of the patient support 12 may occur simultaneously with movement of the imaging source of the imaging machine. Alternatively, the movement of the patient support 12 may occur before or after a movement of the imaging source of the imaging machine.

It should be noted that the mobile patient support 10 is not limited to the configurations and features described above, and that the mobile patient support 10 may have other configurations and/or features in other embodiments. For example, in other embodiments, different supports 12 for different treatments or diagnostic procedures may be provided with the mobile patient support 10. For example, there could be a support configured for use in a procedure to treat a patient's brain, and another support configured for use in a procedure to treat a patient's lung. In some embodiments, one or more of the supports 12 may be a slab top, while one or more other supports 12 may have a top that is articulatable—e.g., a top with different moveable portions, such as a matrix top. During use, depending on the type of surgery, the appropriate support is selected, and is detachably coupled to the remaining part of the mobile patient support 10. Later on, in another procedure, if a different support 12 is needed, the previous support 12 may be decoupled from the mobile patient support 10, and another support 12 for the procedure may be detachably coupled to the mobile patient support 10. In other embodiments, different trackable tops for different treatments or diagnostic procedures may be provided. Also, in some embodiments, the detachable support 12 may be considered to be a separate system from the mobile patient support 10. In such cases, the mobile patient support 10 does not include the support 12. Providing different supports 12 that are available for selection to be coupled to the mobile patient support 10 is advantageous because it increases setup quality and patient throughput.

Also, in other embodiments, the mobile patient support 10 does not have two positioning systems (i.e., a coarse positioning system and a precise/fine positioning system). Instead, if the coarse positioning system is sufficiently accurate, then the mobile patient support 10 does not need the precise positioning system for fine positioning.

In addition, in other embodiments, the secondary wheels 26 are optional, and the mobile patient support 10 does not include the secondary wheels 26. It should also be noted that the mobile patient support 10 is not limited to having wheels, and that the mobile patient support 10 may have other transport mechanisms in other embodiments. For example, in other embodiments, instead of having wheels, the mobile patient support 10 may include moveable legs, crawlers, rotatable ball(s), or any of other devices that are capable of allowing the mobile patient support 10 to move from place to place.

Furthermore, one or more of the degrees of movement for the support 12 described herein may be optional in other embodiments. For example, in other embodiments, the support 12 is not translatable relative to the base of the mobile patient support 10 in the Z-direction. In other embodiments, the support 12 is not translatable relative to the base of the mobile patient support 10 laterally in the X-direction. In further embodiments, the support 12 is not rotatable relative to the base of the mobile patient support 10. Reducing one or more degrees of freedom of movement for the support 12 may provide some cost saving for constructing the mobile patient support 10.

In addition, in other embodiments, the mobile patient support 10 is configured to transport the patient 15 from one operating station to another operation station. Once the target operating station is reached, the patient support 12 is then decoupled from the mobile patient support 10, and coupled to a fixed pedestal that is associated with a machine (e.g., a treatment machine or a diagnostic machine) at the station. In such cases, the mobile patient support 10 is for coarse positioning of the support 12 (and hence the patient 15), which the pedestal at the station is configured for fine positioning of the support 12 (and the patient 15).

In further embodiments, the techniques described herein for determining a position of the patient support 12 may be implemented for a patient support 12 that is coupled to a fixed base (instead of a support that is a part of a mobile patient support). For example, any of the sensors, transmitters (e.g., transmitters 104), and receivers (e.g., receivers 102) described herein may be coupled to a patient support that is coupled to a fixed base.

Computer System Architecture

FIG. 11 is a block diagram that illustrates an embodiment of a computer system 1200 upon which an embodiment of the invention may be implemented. Computer system 1200 includes a bus 1202 or other communication mechanism for communicating information, and a processor 1204 coupled with the bus 1202 for processing information. The processor 1204 may be an example of the processor 120 of FIG. 1, or another processor that is used to perform various functions described herein. In some cases, the computer system 1200 may be used to implement functions of the processor 120. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A patient support system, comprising:
a base having a plurality of wheels; and
a patient support coupled to the base, wherein at least a part of the patient support is for supporting a head of a patient;
wherein at least one of the wheels has a plurality of secondary wheels.

2. The system of claim 1, wherein the at least one of the wheels is configured to rotate about a first axis, and one of the secondary wheels is configured to rotate about a second axis that forms an angle relative to the first axis.

3. The system of claim 1, wherein the patient support is detachably coupled to the base.

4. The system of claim 1, further comprising a positioner coupled to the base, wherein the positioner is configured for positioning the patient support relative to the base.

5. The system of claim 4, wherein the positioner is configured to move the patient support in one or more degrees of freedom selected from the group consisting of a translation about a first axis, a translation about a second axis, a translation about a third axis, a rotation about the first axis, a rotation about the second axis, and a rotation about the third axis.

6. The system of claim 1, further comprising a position determining system for allowing a position, an orientation, or both the position and the orientation, of the patient support to be determined.

7. The system of claim 6, wherein the position determining system includes a component selected from the group consisting of an ultrasound device, a radio frequency device, an ultra wide band radio frequency device, a laser device, a marker, a camera, an odometer, and an inertia navigation device.

8. The system of claim 6, wherein the position determining system includes a communication device coupled to the patient support.

9. The system of claim 6, wherein the position determining system includes a redundancy system for addressing blockage of line-of-sight, insufficient accuracy, or hazard avoidance.

10. A patient support system, comprising:
a patient support;
a transportation mechanism for transporting the patient support;
a positioner for moving the patient support relative to the transportation mechanism; and
a positioning system for determining an actual position associated with the patient support with respect to a multi-dimensional coordinate system;
wherein one of the transportation mechanism and the positioner is for coarse positioning of the patient support, and another one of the transportation mechanism and the positioner is for fine positioning of the patient support.

11. The patient support system of claim 10, wherein the transportation mechanism is for the coarse positioning of the patient support, and the positioner is for the fine positioning of the patient support.

12. The patient support system of claim 10, wherein the positioner is for the coarse positioning of the patient support, and the transportation mechanism is for the fine positioning of the patient support.

13. The patient support system of claim 10, further comprising:
a processor configured to at least partially control the transportation mechanism based at least in part on information regarding a desired position of the patient support.

14. The patient support system of claim 10, wherein the positioning system comprises a signal receiver for receiving a navigation signal.

15. The patient support system of claim 10, wherein the positioning system comprises a signal transmitter for transmitting a navigation signal.

16. The patient support system of claim 10, wherein the transportation mechanism comprises a steering mechanism, and the patient support system further comprises a processor configured to compare an actual position associated with the patient support with the desired position, and generate a signal to control the steering mechanism based at least in part on a result of the comparison.

17. The patient support system of claim 16, wherein the processor is physically coupled to the patient support.

18. The patient support system of claim 16, wherein the processor comprises information regarding one or more obstacles.

19. The patient support system of claim 10, further comprising a processor configured to control the transportation mechanism to move the patient support from one room to another room.

20. The patient support system of claim 10, further comprising a processor configured to control the transportation mechanism to move the patient support from a first operative position associated with a first machine to a second operative position associated with a second machine.

21. The patient support system of claim 20, wherein the first machine is a treatment machine, and the second machine is a diagnostic machine.

22. The patient support system of claim 10, wherein the transportation mechanism includes a plurality of wheels, at least one of the wheels having a plurality of secondary wheels.

23. The patient support system of claim 22, wherein the at least one of the wheels is configured to rotate about a first axis, and one of the secondary wheels is configured to rotate about a second axis that forms an angle relative to the first axis.

24. The patient support system of claim 10, wherein the patient support is detachably coupled to the transportation mechanism.
